(19) United States
(12) Patent Application Publication
(10) Pub. No.: US 2011/0175575 A1
(43) Pub. Date: Jul. 21, 2011

(54) Battery Charging/Discharging System

(75) Inventors: Chen-Yuan Wu, Taoyuan Hsien (TW); Yu-Chang Chien, Taoyuan Hsien (TW); Yao-Nan Wang, Taoyuan Hsien (TW); Han-Chou Liao, Taoyuan Hsien (TW)

(73) Assignee: CHROMA ATE, INC., Taoyuan Hsien (TW)

(21) Appl. No.: 12/885,885

(22) Filed: Sep. 20, 2010

(30) Foreign Application Priority Data
Jan. 19, 2010 (TW) 099101292

(51) Int. Cl. H02J 7/00

(52) U.S. Cl. 320/128

(57) ABSTRACT

A battery charging/discharging system is provided. This system includes a recycling cable and plural charging/discharging controllers. Each of the charging/discharging controllers is corresponding to a battery. When the battery is in a discharging mode, a discharging current outputted from the battery flows to the recycling cable via the charging/discharging controller. When the battery charging/discharging system is operated, the recycling cable has a recycling voltage equal to a DC voltage.

### BACKGROUND OF THE INVENTION

1. Field of the Invention

The invention is related to a testing apparatus, and more particularly, to a testing apparatus designed for a battery charge/discharge system.

2. Description of the Prior Art

With the rapid development of technologies, many different types of electronic products for commercial use, home use and personal use are getting popular. Besides the ornamental consideration, the safety and the durability of the products are also the main problems we are facing. How to extend the life of the products and to avoid user from harmed by the damage of the products also become the major topic of the designers and the manufacturers of the products. Generally speaking, each of the products has to pass through a quality control process before it is sold.

For example, during the manufacturing process of a battery comprised in an electronic product, the manufacturers have to apply a charge/discharge test to the battery to ensure the charge/discharge process of the battery is normal, and the capacity of the battery can match the requirement of the specification of the electronic product.

During the process of the discharging test, if the electricity output by the battery is not be recycled, it will be transformed into large amount of heat which not only wastes a large amount of energy, but also bring a serious problem of heat dissipation to the testing apparatus and the periphery of the testing environment. In view of the problem, the limitation of the testing condition in the safety law is getting restricted, and a standard related to the amount of energy released by discharging the recovered batteries is provided.

The present batteries charge/discharge system essentially comprising a plurality of battery charge/discharge apparatus. Please refer to FIG. 1 which illustrates a transitional battery charge/discharge system. As shown in FIG. 1, two independent operating battery charge/discharge apparatus 10A and 10B run a charge/discharge test for batteries 12A and 12B respectively. The electricity dissipated in the charge/discharge test can only be recycled to the corresponding power supply respectively. The disadvantages of this design are that the electricity cannot be utilized effectively by recycling the electricity dissipated thereon.

Furthermore, most of the present invention is recycled in a form of DC to the electricity system which may decrease the quality of the electricity.

### SUMMARY OF THE INVENTION

An object of the present invention is to provide a Battery charge/discharge system. The battery charge/discharge system, comprising a recycling cable and a plurality of charge/discharge controller, wherein each of the charge/discharge controllers corresponds to a battery respectively, while the battery is in a discharging mode, a discharge current, outputted from the battery, flow to the recycling cable via the charging/discharging controller; wherein, while the battery charge/discharge system is operating, the recycling cable has a recycle voltage, and the recycling voltage is a direct voltage.

To achieve the previous object, the battery charge/discharge system further comprise a power supply connected to charge/discharge controller respectively to charge the battery via the corresponding charge/discharge controller. The battery charge/discharge system also comprise an one way switch, connected between the recycling cable and the power supply, while the one way switch is in a conductive condition, the one way switch allows passage of a current flow from the recycling cable to the power supply, wherein the one way switch is turned on while the battery charge/discharge system is in a stable operation state, the one way switch is turned off while the battery charge/discharge system is in an initial activation state. Furthermore, the one way switch provides a current limit to the current flow to the power supply.

In actual practice, the one way switch comprises a diode.

In actual practice, a source voltage is provided to the charge/discharge controller by the power supply, and each of the charge/discharge controllers correspondingly comprise a booster, when the battery corresponding to the charge/discharge controller is in the discharging mode, the booster boost a discharge voltage to get beyond the source voltage, wherein the discharge voltage is supported from the battery to the recycle cable.

For a better result, the battery charge/discharge system further comprises a central controlling module for controlling the sequence of charging or discharging of the plurality of batteries via the plurality of the charge/discharge controller.

In actual practice, each of the charge/discharge controllers comprises a power supply respectively, while the battery corresponding to the charge/discharge controller is in a charging mode, the power supply charge the battery.

For a better result, each of the charge/discharge controllers respectively comprises an one-way switch connected between the recycling cable and the power supply, while the one-way switch is in a on-state, the one-way switch allows passage of a current flow from the recycling cable to the power supply

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 illustrates a transitional battery charge/discharge system.

FIG. 2A illustrates a function block diagram according to an embodiment of the battery charge/discharge system.

FIG. 2B illustrates a charge/discharge module comprise a booster according to an embodiment of the battery charge/discharge system.

FIG. 2C illustrates a charge/discharge module comprise two charge/discharge group and a central controlling module according to an embodiment of the battery charge/discharge system.

FIG. 2D illustrates a battery charge/discharge system according to another embodiment of the invention.

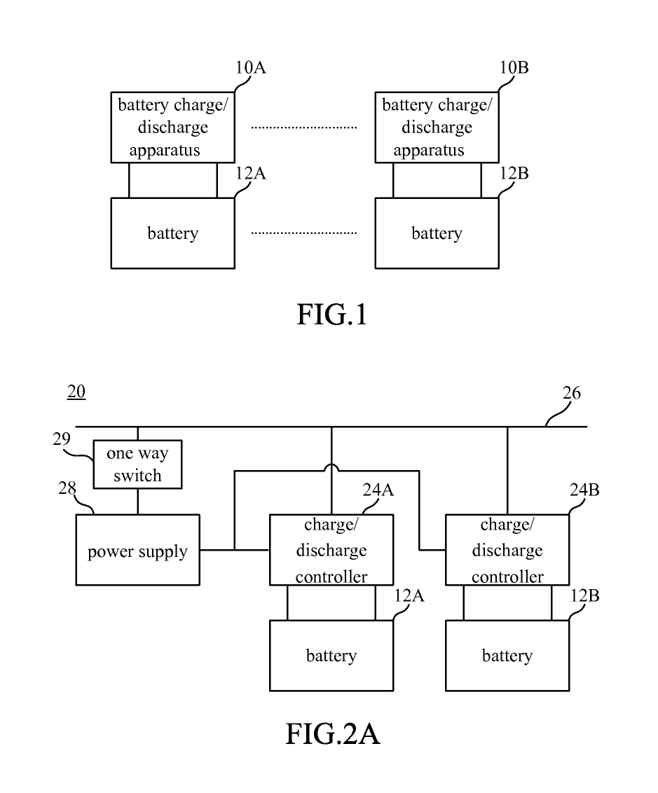

### DETAILED DESCRIPTION OF THE INVENTION

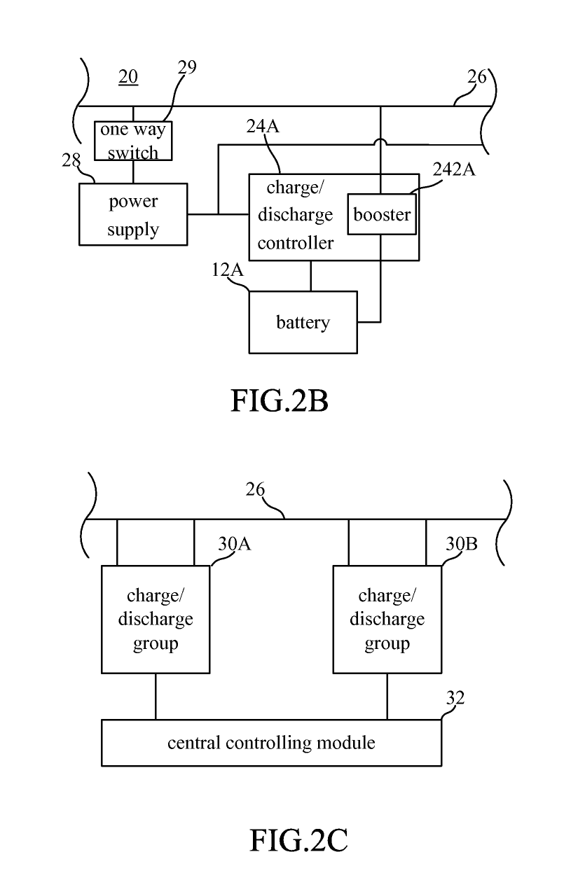

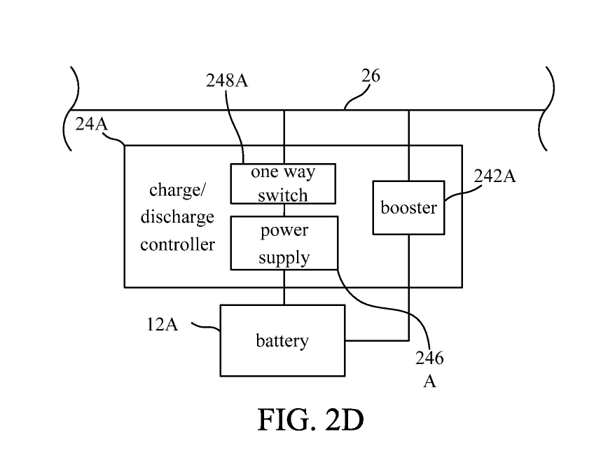

Please refer to FIG. 2A, FIG. 2A illustrates a function block diagram according to an embodiment of the battery charge/discharge system. In actual practice, the system 20 can be, but not limited to a battery charge/discharge testing apparatus. In this embodiment, the system comprise a plurality of charge/discharge controller (only two controller 24A-4B are shown for clear expression)—a recycling cable 26—a power supply 28 and a one way switch 29. In actual practice, the recycling cable 26 can, but not limited to, be manufactured by copper.

As shown in FIG. 2A, each of the charge/discharge controllers of the present embodiment is correspond to a battery respectively (12A-12B). During the charging process, the specification and the voltage requirement of the battery 12A and battery 12B does not required to be the same. As shown in FIG. 2A, the batteries are connected to the recycling cable 26 via the corresponding charge/discharge controller.

More practically, when the battery 12A is in the discharging mode, the discharge current outputted from the charge/discharge controller 24A are directed to the recycling cable 26.

Similarly, while the battery 12B is in discharging mode, the discharge current outputted by the battery 12B is directed to the recycling cable 26.

According to present invention, as shown in FIG. 2A, while the battery charge/discharge system 20 is operating, the recycling voltage on the recycling cable 26 is a DC voltage.

In this embodiment, the power supply 28 is connected to charge/discharge controller 24A and 24B respectively for charging the batteries 12A and 12B in charging mode via charge/discharge controller.

Each of the charge/discharge controllers also having a function of adjusting the voltage for the batteries. For example, if the source voltage outputted by the power supply 28 is fixed to 24 volts, and the charging voltage requirement is 5 volts, then the charge/discharge controller 24A is capable of decreasing the source voltage received to 5 volts before supplied to the battery 12A.

In actual practice, the one way switch 29 can be formed by a diode. As shown in FIG. 2A, the one way switch 29 is connected between the recycling cable 26 and power supply 28. While the one way switch 29 is in conductive conduction, the one way switch 29 only allowing the passage of the current flow from the recycling cable 26 to power supply 28. In another word, the current to flow from the power supply 28 to the recycling cable 26 is not allowed by the one way switch 29.

Besides providing the function of limiting the direction of the flow of the current, the one way switch 29 can also be utilized to limit the current flow toward the power supply 28, so as to avoid the damage of power supply 28 caused by the sudden flow over the afford of the power supply. Furthermore, while the battery charge/discharge system 20 is in the initial activation state, the one way switch 29 can be turned off beforehand, and the one way switch 29 is turned on while the battery charge/discharge system 20 is in a stable operation state.

In additionally, while the power supply 28 is accepting the recycle electricity supplied by the recycling cable 26 via the one way switch 29, the amount of electricity consumed by the recharging of the battery can be decreased.

Furthermore, although the power supply 28 is not charging the battery 12A-12B, the electricity can be transmitted to the charge/discharge controller 24A-24B or any other periphery circuit via the recycling cable 26 for fulfilling the electricity requirement thereof.

Please refer to FIG. 2B, FIG. 2B illustrates a charge/discharge module comprise a booster according to an embodiment of the battery charge/discharge system. In this embodiment, the charge/discharge controller 24A comprise a booster 242A. The booster 242A is utilized for boosting the voltage outputted from the battery 12A to the recycling cable 26. For example, while the voltage output from the power supply 28 is V1 and the one way switch 29 is in conduction state, the pressure difference between the both ends of the one way switch 29 is V2. While the battery 12A is in discharging mode, the booster 242A is capable of boosting the discharging voltage, provided form the battery 12A to recovery cable 26, to (V1+V2) to compensate the pressure drop cause between the recovery cable 26 and the power supply 28.

The other charge/discharge controller of the battery charge/discharge system 20, such as the charge/discharge controller 24B, can also comprise the booster 242A as shown in FIG. 2B. Since the working principle of the charge/discharge controllers are approximately the same, the discussion of unnecessary details will be hereby omitted.

According to present invention, if a plurality of the charge/discharge controller is comprised by the battery charge/discharge system 20, the charge/discharge controllers can be distributed in a plurality of groups. For example, if the battery charge/discharge system 20 comprise two thousand charge/discharge controller such as charge/discharge controller 24A, every hundred of the charge/discharge controllers can be distributed as a group, and a power supply can be shared by the charge/discharge controller every groups simultaneously. In another word, each of the charge/discharge groups comprises a power supply respectively. Furthermore, the said two charge/discharge controller such as charge/discharge controller 24A can also share a power supply.

Please refer to FIG. 2C, FIG. 2C illustrates a charge/discharge module comprise two charge/discharge group and a central controlling module according to an embodiment of the battery charge/discharge system. The central controlling module 32 is utilized to control the charge/discharge group 30A-30B to enter charging mode sequentially. More practically, the function of the central controlling module 32 is to arrange and adjust the charge/discharge sequence of the batteries in the charge/discharge groups for maximizing the efficiency of the energy.

For example, while one of the charge/discharge group 30A is charging the plurality of correspondent batteries, the central controlling module 32 is capable of letting the battery in charge/discharge group 30B into discharging condition and directing the electricity discharged to the recovery cable.

comparatively, while one of the charge/discharge group 30B is charging the plurality of correspondent batteries, the central controlling module 32 is capable of letting the battery in charge/discharge group 30A into discharging condition and directing the electricity discharged to the recovery cable 26. So as to save the energy by utilizing the electricity dissipated among the charge/recharge process reciprocally.

In the system of the present invention, the recycling of the energy no longer limited to a single charge/discharge apparatus to boost the utilization rate of the electricity rapidly. In actual practice, the central controlling module 28 is, but not limited to, a computer system or a single chip microprocessor.

Please refer to FIG. 2D, FIG. 2D illustrates a function block diagram according to an embodiment of the battery charge/discharge system.

In this embodiment, a power supply is comprise in each of the charge/discharge controllers respectively, but not sharing a single power supply with a plurality of charge/discharge controller.

While the batteries correspond to the charge/discharge controller 24A is in the charging mode, the power supply 246A charge the battery 12A. As shown in FIG. 2D, and one way switch is comprised in the charge/discharge controller 24A connected between the recycling cable 26 and the power supply 246A.

While the one way switch 248A is in a conductive conduction, the one way switch 248A allows a circuit flow from the recycling cable 26 to power supply 246A. The same with the said embodiments, the power supply 246A as shown in FIG. 2D is capable of receiving the electricity generated by the discharge of the other batteries for decreasing the electricity consumption of the battery 12A.

Comparatively, the electricity dissipated during the discharging of the battery 12A can be utilized to charge other batteries.

Accordingly, by integrating a plurality of batteries charge/discharge controller, the system and method disclosed by the present invention not only capable of boosting the utilization rate of the energy and also decrease the power consumption of the battery charge/discharge system, but also decreasing the waste heat generated by the energy that is not effectively utilized for solving the heat dissipating problem of the system. Furthermore, In prior art, the quality of electricity is in negatively affected by the recovery electricity, however, in accordance with the system of present invention, the electricity can be recycled in the form of direct current so as to solve the said problem.

According to the battery charge/discharge system and battery charging/discharge method of the present invention, different sizes or capacities of batteries can be utilized, furthermore, the present invention is not only limited to be utilized on testing apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A battery charge/discharge system, comprising:
a recycling cable; and
a plurality of charge/discharge controllers, wherein each of the charge/discharge controllers corresponds to a battery respectively;
wherein when the battery is in a discharging mode, a discharge current, outputted from the battery, flows to the recycling cable via the charging/discharging controllers;
wherein when the battery charge/discharge system is operated, the recycling cable has a recycling voltage equal to a DC voltage.

2. The battery charge/discharge system of claim 1, further comprising:
a power supply connected to the charge/discharge controllers respectively to charge the battery via the corresponded charge/discharge controller.

3. The battery charge/discharge system of claim 2, further comprising:
an one way switch, connected between the recycling cable and the power supply, when the one way switch is in a conductive condition, it allows a current flow from the recycling cable to the power supply passing through.

4. The battery charge/discharge system of claim 3, wherein when the battery charge/discharge system is in a stable operation state, the one way switch is turned on, and when the battery charge/discharge system is in an initial activation state, the one way switch is turned off.

5. The battery charge/discharge system of claim 3, wherein the one way switch comprises a diode.

6. The battery charge/discharge system of claim 3, wherein the one way switch provides a current limit to the current flows to the power supply.

7. The battery charge/discharge system of claim 2, wherein a source voltage is provided to the charge/discharge controllers by the power supply, and each of the charge/discharge controllers correspondingly comprising:
a booster circuit, when the battery corresponds to the charge/discharge controller is in the discharging mode, the booster circuit boosts a discharge voltage provided from the battery to the recycle cable, so as to raise the discharge voltage to be higher than the source voltage.

8. The battery charge/discharge system of claim 2, further comprising:
a central controlling module, for controlling the sequence of charging or discharging of the batteries via the charge/discharge controllers.

9. The battery charge/discharge system of claim 1, wherein each of the charge/discharge controllers comprises a power supply respectively, when the battery corresponds to the charge/discharge controller is in a charging mode, the power supply charges the battery.

10. The battery charge/discharge system of claim 9, wherein each of the charge/discharge controllers respectively comprises:
an one-way switch connected between the recycling cable and the power supply, when the one-way switch is in an on-state, it allows a current flow from the recycling cable to the power supply passing through.
